(19) United States
(12) Patent Application Publication
(10) Pub. No.: US 2004/0207505 A1
(43) Pub. Date: Oct. 21, 2004

(54) Low current fuse cartridge for circuit interrupter

(76) Inventors: Glenn R. Borchardt, Round Lake Beach, IL (US); Jorge R. Montante, Cicero, IL (US); Mark W. Stavnes, Mount Prospect, IL (US); Martin A. Warszawa, Arlington Heights, IL (US)

Correspondence Address: James V. Lapacek, S & C Electric Co., 6601 N. Ridge Blvd., Chicago, IL, 60626, US

(21) Appl. No.: 10/722,892

(22) Filed: Nov. 26, 2003

Related U.S. Application Data
(60) Provisional application No. 60/432,560, filed on Dec. 12, 2002.

(51) Int. Cl. H01H 85/02

(52) U.S. Cl. 337/186

(57) ABSTRACT

A fuse cartridge is provided having improved tensile strength via the provision of a mechanical strain wire that is in parallel with a fusible element mechanically but not electrically, thereby increasing the tensile strength of the fusible element without altering the electrical time-current characteristics of the fusible element. In a preferred embodiment, the strain wire is provided by looping a fusible element wire from a first terminal around a second terminal and back near the first terminal but electrically insulated therefrom.

This application claims the benefit of U.S. Provisional Application No. 60/432,560 filed on Dec. 12, 2002.

### BACKGROUND OF THE INVENTION

1. Field of the Invention

The present invention relates generally to fuse cartridges for circuit-interrupting devices such as fuses, cutouts and the like and more particularly to a low current fuse cartridge having improved tensile strength.

2. Description of the Related Art

Various types of circuit interrupting devices in the electrical power distribution and transmission field utilize fuse cartridges having fusible elements that are designed to provide desirable circuit interrupting characteristics, i.e. time-current characteristics. The available time-current characteristics include protection against fault currents and other overload currents. For example, ANSI standard C37.42 describes various time-current characteristics. The circuit-interrupting devices are utilized at different locations in the electrical systems to provide different functions along with coordinating with one another to provide the most reliable system and minimize outages and the number of affected power users on the system. In order to provide desirable low current time-current characteristics, small diameter fusible elements are required. However, these fusible elements do not have the necessary tensile strength to withstand the spring force of circuit interrupters such as is required for the Fault Tamers Fuse Limiter available from the S&C Electric Company, Chicago, Illinois. A circuit interrupter of this type is shown in U.S. Pat. No. 5,502,427. Accordingly, heretofore, it has not been possible to provide a suitable low current fuse cartridge for such devices. While some prior art fuses provide strain wires in parallel with the fusible element, this is not suitable to achieve low-current fusible elements due to the deleterious effects of the strain wire on the time-current characteristics.

While the fusible elements of the prior art may be generally suitable for their intended uses, it would be desirable to provide a low current fuse cartridge having improved tensile strength.

### SUMMARY OF THE INVENTION

Accordingly, it is a principal object of the present invention to provide a low current fuse cartridge having improved tensile strength.

These and other objects of the present invention are efficiently achieved by a fuse cartridge having improved tensile strength via the provision of a mechanical strain wire that is in parallel with a fusible element mechanically but not electrically, thereby increasing the tensile strength of the fusible element without altering the electrical time-current characteristics of the fusible element. In a preferred embodiment, the strain wire is provided by looping a fusible element wire from a first terminal around a second terminal and back near the first terminal but electrically insulated therefrom.

### BRIEF DESCRIPTION OF THE DRAWING

The invention, both as to its organization and method of operation, together with further objects and advantages thereof, will best be understood by reference to the specification taken in conjunction with the accompanying drawing in which:

FIG. 1 is an elevational view, partly in section and with parts cut away for clarity, of a fuse cartridge in accordance with a first embodiment of the present invention;

FIG. 2 is a top plan view of portions of the fuse cartridge of FIG. 1;

FIG. 3 is a partial view of an alternate embodiment of the fuse cartridge of FIG. 1; and

FIG. 4 is a partial view of yet another alternative embodiment of the fuse cartridge of FIG. 1.

### DETAILED DESCRIPTION

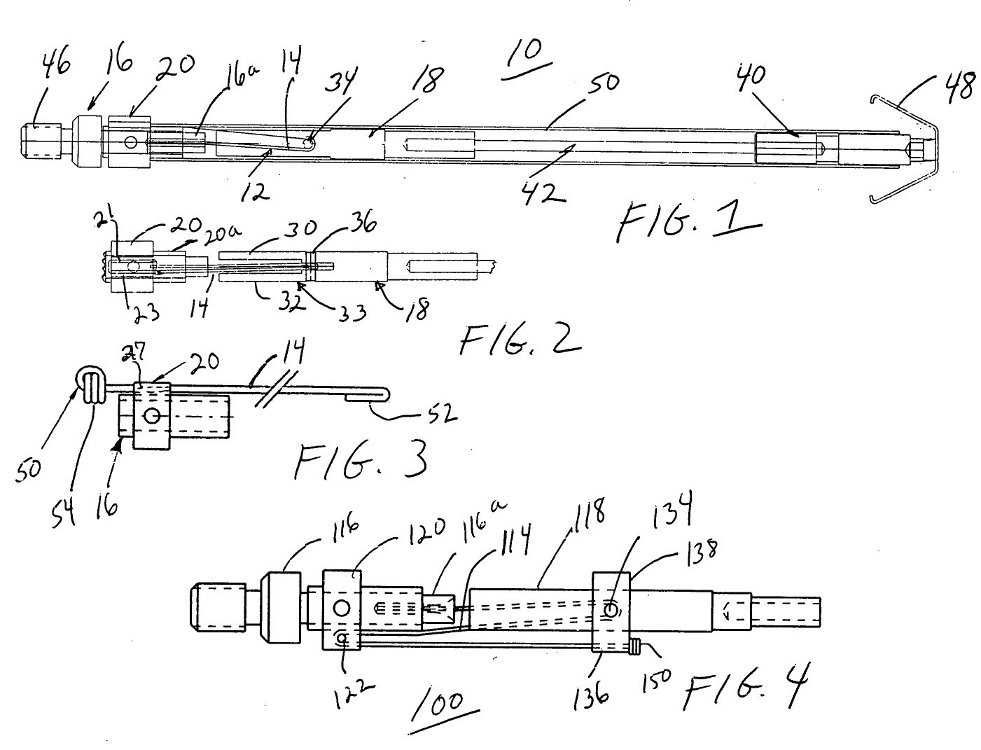

Referring now to FIGS. 1 and 2, there is illustrated a fuse cartridge 10 in accordance with a first illustrative embodiment of the present invention that is suitable for use as the fuse cartridge 52 of U.S. Pat. No. 5,502,427. While the fuse cartridge 10 of the illustrative embodiment includes certain features for specific adaptation to the fuse limiter of the 5,502427 patent, it should be understood that the principles of the improved tensile strength low-current fuse cartridge of the present invention are applicable for use with other types and forms of circuit interrupters as well. The fuse cartridge 10 includes a fusible element 12 having an element wire 14 that defines the time-current characteristics of the fuse cartridge 10 and that is disposed between an upper terminal 16 and a element terminal 18, e.g. being electrically connected to a lower portion 16a of the upper terminal 16 by a swaging operation or the like.

In accordance with important aspects of the present invention, the element wire 14 is looped around the element terminal 18 and is mechanically secured to an insulating portion 20 of the upper terminal 16, e.g. the insulating portion 20 being a circular member affixed to and carried by the upper terminal 16 and also including a lower extending portion 20a. In the specific arrangement as shown in FIG. 2, the wire element 14 is looped through passages 21, 23 in the insulating portion 20 and tied back upon itself.

Thus, the fuse cartridge 10 exhibits the electrical properties of one wire and the mechanical properties of two parallel wires. In this manner, the electrical time-current characteristics of a single wire element are provided along with the increased mechanical tensile strength of two wires.

Specifically, in the illustrative embodiment, the element terminal 18 of the fuse cartridge 10 includes a forked portion 33 defined by times 30, 32 and a pin 34 that is passed through an aperture 36 of the element terminal 18 that also communicates with the forked portion 33. The element wire 14 is looped around the pin 34. The element terminal 18 is electrically and mechanically connected to a lower terminal 40 via a flexible cable arrangement 42 that is affixed at either end to the terminals 18 and 40 respectively. It should be noted that to achieve appropriate operation, the wire element 14 upon melting must also release the terminals 16, 18 for relative separation. In the arrangement shown, this is achieved by the wire element 14 being freely looped about the pin 34.

In the illustrative embodiment adapted for use with the fuse of the aforementioned U.S. Pat. device 5,502,427, the upper terminal 16 of the fuse cartridge 10 includes a threaded portion 46 for assembly into the fuse and the lower terminal 40 includes a retention arrangement 48 in the form of a clip for loading and assembly into the fuse. The flexible cable arrangement 42 collapses upon operation of the fuse cartridge 10 thus providing desirable space within the fuse tube assembly 15 of the aforementioned patent. This also establishes a relatively short length of the element terminal 18. The forked portion 33 serves additional functions as a corona shield and mechanically protects the element wire 14 during handling and assembly by functioning as a stop that abuts the upper terminal 16. The fuse cartridge 10 includes an outer sheath 50 affixed over the upper and lower terminals 16, 40 and attached to the upper terminal 16. In preferred arrangements, the outer sheath 50 is fabricated from arc-extinguishing material. Upon assembly of the fuse cartridge 10 into a fuse, the tension is applied to the fuse cartridge 10, i.e. across the upper terminal 16 and the retention arrangement 48 of the lower terminal 40.

Considering other aspects of the present invention and referring now to FIG. 3, an alternate arrangement for securing the wire element 14 to the insulating portion 20 includes passing the wire element 14 through a passage 27 in the insulating portion 20, the wire element 14 at the upper end thereof including a mechanical stop 50. Also illustrated is a bend 52 in the wire element 14 at the other end thereof for improved attachment to the upper terminal 16, i.e. after being looped around the pin 34 as shown in FIGS. 1 and 2. In one specific arrangement, the mechanical stop 50 is readily achieved by the end of the wire element 14 being formed in a multi-turn coil 54 and the other end being looped through the coil 54 and pulled tightly to secure the wire element and define the stop 50.

Referring now to FIG. 4 and considering additional aspects of the present invention, an alternative embodiment of a fuse cartridge 100 provides the electrical properties of one wire and the mechanical properties of three parallel wires. In this manner, the electrical time-current characteristics of a single wire element are provided along with a mechanical tensile strength triple that of a single wire, i.e. three wires. Specifically, the wire element 114 including a mechanical stop 150 passes through a passage 136 of a member 138 carried by the element terminal 118. Then the wire element 114 is looped around a pin 122 of an insulating portion 120 carried by the upper terminal 116 and back to loop around a pin 134 of the element terminal 118. Then, the wire element 114 is electrically connected and mechanically secured to the lower portion 116a of the upper terminal 116. When the wire element experiences an overcurrent and melts, the element wire 114 is released and the terminals 116, 118 separate. As discussed hereinbefore, it should be understood that the wire element 114 upon melting must be capable of freely moving under spring tension about the pins 134 and 122 to permit the appropriate separation of the terminals 116,118.

While there has been illustrated and described a preferred embodiment of the present invention, it will be apparent that various changes and modifications will occur to those skilled in the art. Accordingly, it is intended in the appended claims to cover all such changes and modifications that fall within the true spirit and scope of the present invention.

1. A fuse cartridge comprising a fusible element electrically connected between two terminals and a second element mechanically connected in parallel with said fusible element.

2. The fuse cartridge of claim 1 wherein said second element is provided by looping the fusible element about one of said terminals and mechanically connected at the other end to an insulating portion of the other of said terminals.

3. A fuse cartridge having two terminals that provides the electrical properties of a single wire element and the mechanical tensile strength of two or more wires, the two or more wires being provided by looping the single wire element back and forth between the two terminals, a single length of the wire element being electrically connected between the two terminals and having one or more additional lengths of wire element being mechanically connected in between the two terminals but electrically insulated from at least one of the two terminals.
